(19) United States
(12) Patent Application Publication
(10) Pub. No.: US 2002/0059398 A1
(43) Pub. Date: May 16, 2002

(54) Voice banner advertisement system and voice banner advertisement method

(76) Inventor: Moriaki Shimabukuro, Tokyo (JP)

Correspondence Address: McGinn & Gibb, PLLC, Suite 200, 8321 Old Courthouse Road, Vienna, VA, 22182-3817, US

(21) Appl. No.: 09/987,407

(22) Filed: Nov. 14, 2001

(30) Foreign Application Priority Data
Nov. 15, 2000 (JP) 2000-347901

(51) Int. Cl. G06F 17/60; G06F 15/16

(52) U.S. Cl. 709/218; 705/14; 709/231

(57) ABSTRACT

A user transmits the designated information of Web page data desired to be browsed to a Web server through a network by using a user terminal. The Web server constitutes Web page data by advertisement data of a advertiser and contents data to transmit the Web page data to the user terminal, and records history information of banner advertisements. The user terminal which receives the Web page data extracts the banner advertisement data from the Web page data, and read the banner advertisement by voice synthesis the moment a Web page is displayed. An information offerer who manages the Web server demands payment of an advertising charge from the advertiser on the basis of the history information of the banner advertisement.

### FIELD OF THE INVENTION

The present invention relates to a voice banner advertisement system and a voice banner advertisement method each of which offers a voice advertisement during Web page access to the user of portable terminals with a small-area information display.

### BACKGROUND OF THE INVENTION

Many users access Web pages on the Internet by using terminals equipped with a large-area display unit. As shown in FIG. 1, the large-area display unit has a display area 20 that is generally composed of a contents data display area 21 for displaying contents data requested by a user and a banner advertisement display area 22. Since the banner advertisement display area 22 only needs a much smaller display area than the contents data display area 21, the banner advertisement can be displayed while displaying a sufficient amount of contents data.

In recent years, Internet access can be made through a portable terminal such as a portable telephone, and an advertisement system for portable terminals is demanded since they are expected to have a higher diffusion rate than desk-top personal computers.

However, since the display unit of portable terminals such as a portable telephone is very compact, if a banner advertisement is displayed with contents data it must considerably reduce the amount of contents data to be displayed. As a result, the essential effect of a banner advertisement which is obtained by attaching the banner advertisement to contents data is lost disadvantageously.

### SUMMARY OF THE INVENTION

The present invention has been made in consideration of the above circumstances, and has as its object to provide a voice banner advertisement system and a voice banner advertisement method each of which offers a voice advertisement during Web page access to the user of portable terminals with a small-area information display.

According to a first aspect of the present invention, there is provided a voice banner advertisement system for performing an advertisement with voice including: (a) a Web server constituted by Web page data transmission means for constituting contents data and advertisement data to be offered to a user to transmit the Web page data and history information recording means for recording the number of times at which a banner advertisement is transmitted as history information; and (b) a user terminal constituted by communication means for performing data communication with the Web server through the internet, Web page browsing means for browsing a Web page offered by the Web server, and voice synthesis means for extracting banner advertisement data from the received Web page data and converting the banner advertisement data into voice by voice synthesis to utter the banner advertisement data.

In the voice banner advertisement system according to a second aspect of the present invention, the user terminal further includes voice synthesis operation setting means for setting whether the voice synthesis means is made valid or not and transmitting the setting contents to the Web server, and the Web server transmits the advertisement data to the user terminal only when the voice synthesis means is valid.

According to a third aspect of the present invention, there is provided a Web server for performing an advertisement to a user terminal connected to the Web server including: operation setting information reception means for receiving operation setting information representing whether voice synthesis is valid or not in the user terminal; Web page data transmission means for constituting Web page data including advertisement data on the basis of the operation setting information to transmit the Web page data; and history information recording means for recording the number of times at which a banner advertisement is transmitted as history information.

According to a fourth aspect of the present invention, there is provided a user terminal for uttering received advertisement data with voice including: communication means for performing data communication with a Web server through the internet; Web page browsing means for receiving Web page data offered by the Web server to browse the Web page data; and voice synthesis means for extracting banner advertisement data from the received Web page data and converting the banner advertisement data into voice by voice synthesis to utter the banner advertisement data.

The user terminal according to a five aspect of the present invention further includes voice synthesis operation setting means for setting whether the voice synthesis means is made valid or not and transmitting the setting contents to the Web server.

According to a sixth aspect of the present invention, there is provided a voice banner advertisement method for performing an advertisement with voice including: the Web page data transmission step of constituting contents data and advertisement data offered to a user to transmit the Web page data; the history information recording step of recording the number of times at which a banner advertisement is transmitted as history information; and the voice synthesis step of extracting banner advertisement data from the received Web page data and converting the banner advertisement data into voice by voice synthesis to utter the banner advertisement data.

According to a seventh aspect of the present invention, the voice banner advertisement method further includes the operation setting step of setting whether advertisement data is uttered with voice by the voice synthesis or not, and the web page data including advertisement data is transmitted only when the voice synthesis operation is valid.

### BRIEF DESCRIPTION OF THE DRAWINGS

The invention will be explained in more detail in conjunction with the appended drawings, wherein:

FIG. 1 is a diagram for explaining display areas of a conventional terminal;

FIG. 2 is a block diagram showing configuration of an embodiment of the present invention;

FIG. 3 is a sequence chart showing an operation of the embodiment;

FIG. 4 is a sequence chart showing an operation of another embodiment;

FIG. 5 is a diagram for explaining an example of contents data;

FIG. 6 is a diagram for explaining an example of advertisement data, and;

FIG. 7 is a diagram for explaining an example of Web page data.

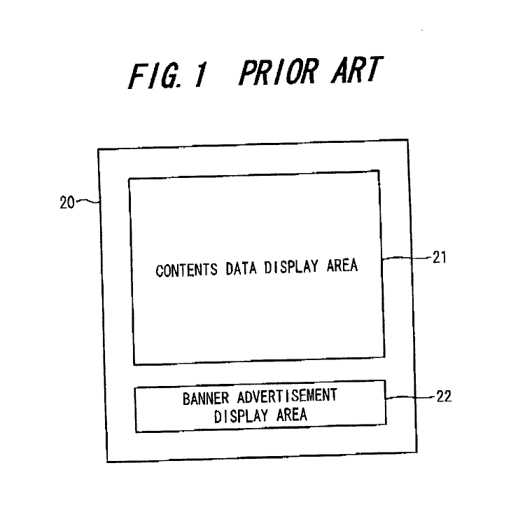

### DESCRIPTION OF THE PREFERRED EMBODIMENTS

A voice banner advertisement system according to an embodiment of the present invention will be described below with reference to the accompanying drawings.

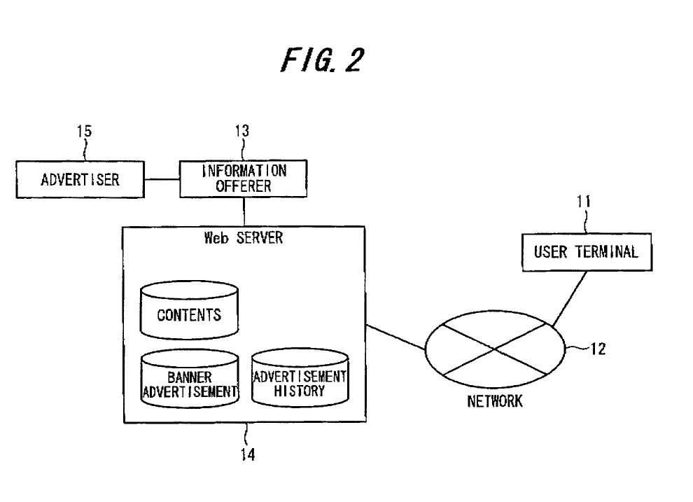

FIG. 2 is a block diagram showing the configuration of the embodiment. In FIG. 2, reference numeral 11 denotes a user terminal having a Web page browsing function and a voice synthesis function for extracting banner advertisement data and converting the banner advertisement data into voice by voice synthesis to utter the advertisement data. The user terminal 11 can access to a Web server or the like by a wireless network through the internet. Reference numeral 12 denotes a network such as the internet. Reference numeral 13 denotes an information offerer 13. Reference numeral 14 denotes a web server having a function of constituting Web page data by various contents data to be offered to a user and advertisement data to transmit the Web page data and a function of recording history information of banner advertisements transmitted to the user terminal 11. In this case, the contents data are information stored in the Web server 14 by the information offerer as information which is worthy for a user. Reference numeral 15 denotes an advertiser.

The advertiser 15 requests the information offerer 13 to perform an advertisement. In response to the request, the information offerer 13 registers contents offered to a user on the Web server 14, and the information offerer 13 registers the banner advertisement data of the advertisement requested by the advertiser 15. The information offerer 13 demands payment of advertising charges from the advertiser 15 in accordance with the number of times of advertisement performed to the user terminal 11.

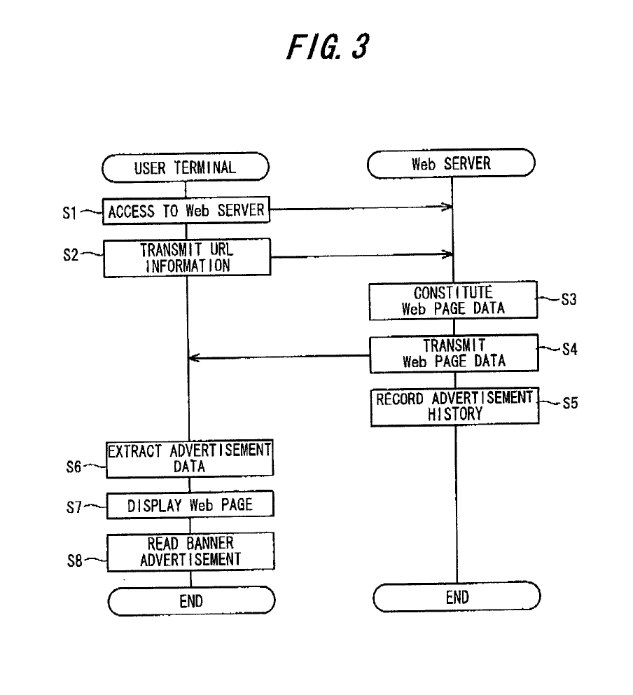

An operation of a voice banner advertisement system shown in FIG. 2 will be described below with reference to FIG. 3. FIG. 3 is a sequence chart showing the operations of the user terminal 11 and the Web server 14. A user uses the user terminal 11 to access the Web server 14 through the network 12 (step Si). After the access, the URL information of a Web page desired to be browsed is transmitted to the Web server 14 (step S2)

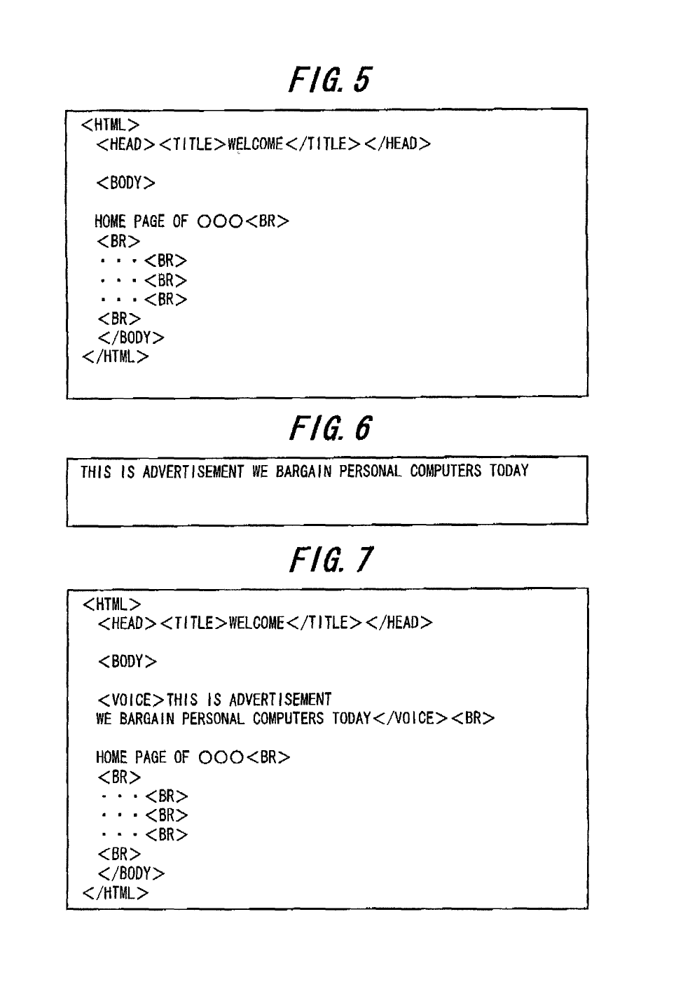

The Web server 14 constitutes Web page data by designated contents data and designated banner advertisement data when the Web server 14 receives the URL information (step S3). Subsequently, the Web server 14 transmits the constituted Web page data to the user terminal 11 (step S4). Upon completion of the transmission, the Web server 14 records history information of banner advertisements (step S5). An example of the contents data is shown in FIG. 5. An example of advertisement data is shown in FIG. 6. FIG. 7 shows an example of the Web page data constituted in step S3. In FIG. 7, banner advertisement data (“This is advertisement. We bargain personal computers today.”) is incorporated as a voice synthesis tag (VOICE tag).

The user terminal 11 receives the Web page data transmitted from the Web server 14. The Web page data is temporarily stored in the user terminal 11. The user terminal 11 extracts banner advertisement data from the temporarily stored Web page data (step S6). Subsequently, the user terminal 11 displays the Web page data on the display unit except for the banner advertisement (step S7). At this time, when the banner advertisement data is included in the Web page data, the user terminal 11 converts the banner advertisement data into voice data to utter the banner advertisement data by voice synthesis (step 5B). In this manner, the banner advertisement data (in this case, “This is advertisement. We bargain personal computers today.” serves as data to be uttered) is read.

In this manner, since the banner advertisement is read with voice, the problem of a shortage of the display area can be solved.

Another embodiment of the present invention will be described below with reference to the accompanying drawings.

This embodiment is different from the above described embodiment in that, after an access to the Web server 14, operation setting information of a voice synthesis function of the user terminal 11 is transmitted before URL information is transmitted. As the operation setting information is information representing whether the voice synthesis function of the user terminal 11 is set to be invalidly operated or not. Therefore, the user terminal 11 has a function used when a user selects the valid/invalid of the voice synthesis function.

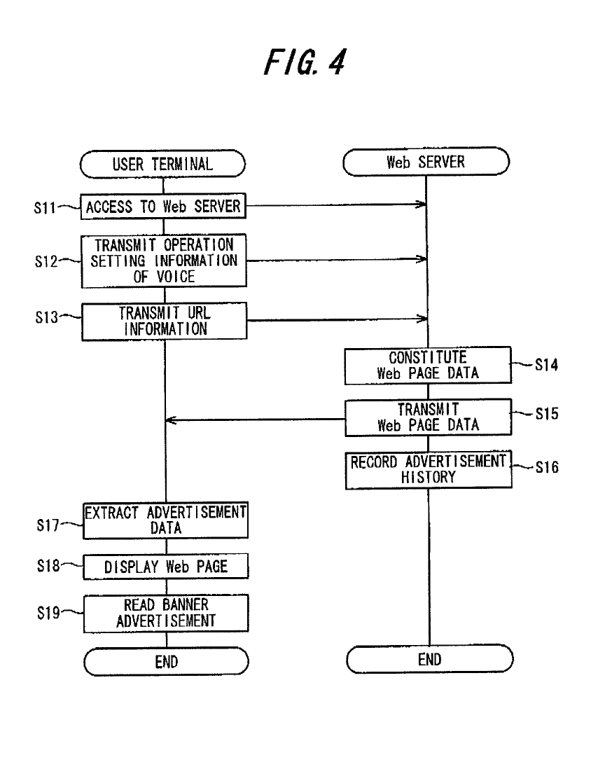

Operations of the user terminal 11 and the Web server 14 in another embodiment will be described below with reference to FIG. 4. FIG. 4 is a sequence chart showing the operations of the user terminal 11 and the Web server 14 in another embodiment.

A user accesses the Web server 14 by using the user terminal 11 through the network 12 (step S11). After the user terminal 11 is connected to the Web server 14, setting information of a voice synthesis function is transmitted to the Web server 14 (step S12). The setting information is temporarily stored in the Web server 14, Subsequently, the user terminal 11 transmits the URL information of a Web page desired to be browsed to the Web server 14 (step S13).

The Web server 14 constitutes Web page data by designated contents data and designated banner advertisement data when the Web server 14 receives the URL (step S14). At this time, when the voice synthesis function of the user terminal 11 is valid, the Web server 14 constitutes the Web page data by the contents data and the banner advertisement data. When the voice setting function is invalid, as shown in FIG. 5, the Web page data is constituted by only the contents information without the banner advertisement data.

Subsequently, the Web server 14 transmits the constituted Web page data to the user terminal 11 (step S15). Upon completion of the transmission, the Web server 14 records history information of banner advertisements. When the voice synthesis function of the user terminal 11 is valid, the history information of the banner advertisements is recorded. However, when the voice synthesis function is invalid, the recording operation is not performed (step S16). FIG. 5 shows an example of contents data which does not include a banner advertisement. FIG. 6 shows an example of advertisement data. FIG. 7 shows an example of Web page data constituted in step S14 and including the banner advertisement. In FIG. 7, banner advertisement data (“This is advertisement. We bargain personal computers today.”) is incorporated as a voice synthesis tag (VOICE tag).

The user terminal 11 receives the web page data transmitted from the Web server 14. The Web page data is temporarily stored in the user terminal 11. The user terminal 11 extracts banner advertisement data from the temporarily stored Web page data (step S17). Subsequently, the user terminal 11 displays the Web page data on the display unit except for the banner advertisement (step S18). At this time, when the banner advertisement data is included in the Web page data, the user terminal 11 converts the banner advertisement data into voice data to utter the banner advertisement data by voice synthesis (step S19). In this manner, the banner advertisement data (in this case, “This is advertisement. We bargain personal computers today.” serves as data to be uttered) is read.

As described above, under the using conditions such as conditions of a theater under which utterance causes a trouble, a user who makes the voice synthesis function of the user terminal 11 invalid can be watch the Web page data without hearing the voice of the banner advertisement. In addition, the valid/invalid of the voice synthesis function is decided, and history information is recorded on the basis of the decision result. For this reason, payment of an excessive advertising charge can be avoided from being demanded from an advertiser.

As has been described above, according to the present invention, when an advertisement is expressed with voice in place of a text and an image, the banner advertisement need not be displayed, or the display of the banner advertisement can be made minimum. For this reason, an advantage that contents information desired by a user can be maximally displayed in a display area included in a terminal can be achieved.

When banner advertisement data is transmitted to a user terminal as text data, and when voice synthesis is performed by the user terminal, an increase of an amount of communication data by adding the banner advertisement data can be minimized. For this reason, communication cost can be reduced, and the feeling of resistance to a banner advertisement of a user can be advantageously suppressed.

In addition, when an advertisement is read by voice synthesis, a secondary advertisement effect to persons who are in a cover area of the voice is advantageously expected.

Although the invention has been described with respect to specific embodiment for complete and clear disclosure, the appended claims are not to be thus limited but are to be construed as embodying all modification and alternative constructions that may be occurred to one skilled in the art which fairly fall within the basic teaching herein set forth.

What is claimed is:

1. A voice banner advertisement system for performing an advertisement with voice comprising:
(a) a Web server constituted by
Web page data transmission means for constituting contents data and advertisement data to be offered to a user to transmit the Web page data and
history information recording means for recording the number of times at which a banner advertisement is transmitted as history information; and
(b) a user terminal constituted by
communication means for performing data communication with the Web server through the internet,
Web page browsing means for browsing a Web page offered by the Web server, and
voice synthesis means for extracting banner advertisement data from the received Web page data and converting the banner advertisement data into voice by voice synthesis to utter the banner advertisement data.

2. A voice banner advertisement system according to claim 1, the user terminal further comprises:
voice synthesis operation setting means for setting whether the voice synthesis means is made valid or not and transmitting the setting contents to the Web server, and
the Web server transmits the advertisement data to the user terminal only when the voice synthesis means is valid.

3. A Web server for performing an advertisement to a user terminal connected to the Web server comprising:
operation setting information reception means for receiving operation setting information representing whether voice synthesis is valid or not in the user terminal;
Web page data transmission means for constituting Web page data including advertisement data on the basis of the operation setting a information to transmit the Web page data; and
history information recording means for recording the number of times at which a banner advertisement is transmitted as history information.

4. A user terminal for uttering received advertisement data with voice comprising:
communication means for performing data communication with a Web server through the internet;
Web page browsing means for receiving Web page data offered by the Web server to browse the Web page data; and
voice synthesis means for extracting banner advertisement data from the received Web page data and converting the banner advertisement data into voice by voice synthesis to utter the banner advertisement data.

5. A user terminal according to claim 4, further comprising:
voice synthesis operation setting means for setting whether the voice synthesis means is made valid or not and transmitting the setting contents to the Web server.

6. A voice banner advertisement method for performing an advertisement with voice comprising:
the Web page data transmission step of constituting contents data and advertisement data offered to a user to transmit the Web page data;
the history information recording step of recording the number of times at which a banner advertisement is transmitted as history information; and
the voice synthesis step of extracting banner advertisement data from the received Web page data and converting the banner advertisement data into voice by voice synthesis to utter the banner advertisement data.

7. A voice banner advertisement method according to claim 6, further comprising.
the operation setting step of setting whether advertisement data is uttered with voice by the voice synthesis or not, and
wherein the Web page data including advertisement data is transmitted only when the voice synthesis operation is valid.
